(19) United States
(12) Patent Application Publication
(10) Pub. No.: US 2022/0053159 A1
(43) Pub. Date: Feb. 17, 2022

(54) All purpose video/audio recorder and media player

(71) Applicant: Pasquale Falino, Belleville, NJ (US)

(72) Inventor: Pasquale Falino, Belleville, NJ (US)

(21) Appl. No.: 16/873,498

(22) Filed: Jun. 19, 2020

(51) Int. Cl. H04N 5/775; H04N 21/4363

(52) U.S. Cl. CPC H04N 5/7755; H04N 21/43635

(57) ABSTRACT

Functions and Features

As a multifunction HD media player to play any format audio, video. Compact and easy, it will become a good companion for home entertainment.

1. USB storage: build in NAND flash enables it as a USB 3.0 storage, with 128 gb capacity, it can easily connect to any USB HOST port, no external power supply needed. Compatible with both Windows and MAC OS.
2. USB HOST: can drive external USB storage devices such as USB HDD or USB pen drive, and play or manage files on them.
3. SD/SDRC reader: Directly read SD/SDRC card, and play or manage files on it.
4. Video decoding formats: RM, RMVB, AVI, DIVX, MKV, MOV, HDMOV, MP4, M4V, PMP, AVC, FLV, VOB, MPG, DAT, MPEG, TS, TP, M2TS, WMV, H.264, H.263, WMV9/VC-1, MPEG1/2/4 Video definition: 1920×1080×60P standard with choices in 50 HZ/60 HZ, 720P, 7201, 480, NTSC, PAL, Bitrate: up to 80 Mbps
5. Audio types: MP3, WMA, OGG, AAC, FLAC, APE, AC3, DTS, ATRA.
6. Photo: JPEG, TIF, PNG, BMP.
7. Optional functions: With enhanced hardware of DDR and Win CE embedded 6.0 OS, can play flash .SWF and MS office file (Office 2003), .PDF and other OS

This box is an all-purpose video and audio recorder with built in media player. The capability of plugging the unit from the front into the back of a TV with HD video cable will let the user record from any available source that is attached of the unit from the back. High Definition Copy Protection will let you bypass any security to record from SAT/Cable Receiver, DVD player, Game Boxes in any video format and audio to be in only MP3 format to be controlled by universal remote control.

Circuitry internal shall be built in accordance to manufacturer capability. AV in audio slot, HDMI out slot, SD micro slot and remote sensor will be mounted on the front of the unit. The right side of the unit will have a selectable PAL/NTSC switch for final recording. The left side will a USB slot and standard SD card slot which will control the media player functions. The back of the unit will feature 120 vac plug electrical cable, antenna and TV round NTSC plugs, 3 HDMI input slots.

System: Android (current mode)

Core: Quad Core

RAM: 2G

RAM Type: DDR4

ROM: 16G

Internal SATA card 512 GB. if SD slot from housing is used saving video or audio will be stored in card slot.

TV Box Features: 5.1 Surround Sound Output

Color: Black

Media Supported: HD MPEG1/2/4, H.263, H.264, H.265

Video format: 4K, AVI, DAT, H.265, ISO, MKV, MP4, MPEG, MPEG1, MPEG2, MPEG4, RM, WMV, FLV

Audio format: AAC, DTS, FLAC, MP3, OGG, RM, WMA

Photo Format: GIF, JPEG, JPG, PNG, PDF

Support 5.1 Surround Sound Output: Yes

Aluminum housing cooling IP68, bullet proof housing with breather holes on the bottom of unit.

Product Details

AV input connects to any audio, cd player, cassette player, 45 record and LP player attachments.

5G Wi-Fi: Yes

WIFI: 802.11 a/b/g/n/ac

Bluetooth: Bluetooth (current version at time of manufacturing)

Power Supply: Charge Adapter

Interface: DC Power Port, HDMI, LAN, RJ45, SD Card Slot, SPDIF, USB2.0, USB3.0

Language: World wide Multi-language

As a multifunction HD media player to play any format audio, video.

1. USB storage: build in NAND flash enables it as a USB 3.0 storage, with 128 gb capacity, it can easily connect to any USB HOST port, no external power supply needed.

2. USB HOST: can drive external USB storage devices such as USB HDD or USB pen drive, and play or manage files on them.

3. SD/SDHC reader: Directly read SD/SDHC card, and play or manage files on it.

4. Video decoding formats: RM, RMVB, AVI, DIVX, MKV, MOV, HDMOV, MP4, M4V, PMP, AVC, FLV, VOB, MPG, DAT,

MPEG, TS, TP, M2TS, WMV, H.264, H.263, WMV9/VC-1, MPEG1/2/4

Video definition: 1920×1080×60P standard with choices in 50 HZ/60 HZ, 720P, 7201, 480, NTSC, PAL,

Bitrate: up to 80 Mbps

5. Audio types: MP3, WMA, OGG, AAC, FLAC, APE, AC3, DTS, ATRA.

6. Photo: JPEG, TIF, PNG, BMP.

7. Optional functions : With enhanced hardware of DDR and Win CE embedded 6.0 OS, can play flash .SWF and MS office file (Office 2003), .PDF and other OS

8. Box remote will also function in media player. Power on/off button, play, pause, stop, forward, reverse, volume up/down, numeric display 1-9, mute, Rev-Forw or Fast Rev/Forw, Prey-Next, Hold, Repeat, zoom, timer, fav Vol up or down. One Touch Recording, Source: Audio, TV, Antenna, HDMI 1, HDMI2, HDMI3 in 720, 480, or 4K. If recording from smart box whichever format you choose from streaming the video, it will record in that format. If recording from any HDMI it will record auto from source in input. File size remaining will be displayed at startup during recording. Media Source button to function for ANT, HDMI 1, HDMI2, HDMI3 or AV (also in cable YbPR) Audio. Other functions: Menu (Setup functions), channel up/channel down, right/left arrow keys. OK button in middle. Last, zoom, EPEG, CC, Go To, Info, Exit, Mode, Mute, Zoom,

1. Preamble and Transition: An electronic unit that when hooking up by means of a HDMI cable connecting to a television to be viewed for recording from 3 different sources.
A: A RF connector composing of 2 to be hooked up to an antenna and the other to the back of TV for viewing and recording purposes.
B: Electrical ports of HDMI when connected from different viewing apparatus shall be recorded to internal or external media to be viewed on to TV for future use.
C: A single 3.5 mm peripheral in front of unit that when connected shall be allowed to be recorded from another audible source.
D: A single pole, single throw switch to be carried out in the event of being used for worldwide usage.
E: A slot for viewing and playing audio and video media.
